(19) United States
(12) Patent Application Publication
(10) Pub. No.: US 2023/0036001 A1
(43) Pub. Date: Feb. 2, 2023

(54) VEHICLE ENERGY MANAGEMENT AND STORAGE SYSTEM

(71) Applicant: Worthen Innovative Power Solutions, LLC, Santaquin, UT (US)

(72) Inventors: Todd Goodrich, Washington, UT (US); Carter Worthen, Santaquin, UT (US)

(73) Assignee: Worthen Innovative Power Solutions, LLC, Santaquin, UT (US)

(21) Appl. No.: 17/815,929

(22) Filed: Jul. 28, 2022

Related U.S. Application Data
(60) Provisional application No. 63/226,932, filed on Jul. 29, 2021.

(51) Int. Cl. B60R 16/033; H02J 7/00; H02J 7/35

(52) U.S. Cl. CPC B60R 16/033; H02J 7/00712; H02J 7/0029; H02J 7/35; H02J 2300/24

(57) ABSTRACT

A vehicle energy management and storage system has a first connection from a crank battery to a first breaker, a second connection for the breaker to a DC-DC battery charger, a third connection from the DC-DC battery charger to second breaker, and a fourth connection from the second breaker to one or more storage batteries. The storage batteries are electrically coupled, through a fuse, to a power inverter for inverting 12V DC to 110 AC, which supplies AC power to an outlet. This allows a user to capture, store, and utilize excess energy generated by a vehicle alternator, and in some examples, solar panels.

### CROSS-REFERENCE TO RELATED APPLICATIONS

This application claims the benefit of U.S. Provisional Application Ser. No. 63/226,932, filed on Jul. 29, 2021, which is incorporated herein by reference.

### TECHNICAL FIELD

The present disclosure relates to power management in a vehicle. More particularly, the present disclosure relates to power management systems for vehicles and storing excess power generated by the vehicle.

### BACKGROUND

As truck operators transport goods across the country, the drivers often park for the evening to rest. It is common practice for drivers to idle their trucks while they are sleeping in the cab, which allows them to run climate controls and power other items, such as a refrigerator, television, and many other accessories.

The problem associated with this type of habit or behavior is that fuel is being consumed at a substantial rate each night and will continue throughout the entire life of the truck, thus resulting in an extremely large financial cost over time for the operating company. Additionally, this produces an enormous amount of unnecessary emissions into our atmosphere. Accordingly, there is a need for a system that can provide power to the cab while the engine is not running, thereby lessening fuel consumption and emissions.

Likewise, in the industrial work environment, workers are in need of power for their tools and equipment. Currently, the only suitable form of a portable power supply is a gasoline or diesel-powered generator. The problem with these generators is the continual maintenance associated with each of them, especially if they are not used frequently, as well as the dependence on fuel to run them. And as previously described, the emissions from these fuel burning generators is often unnecessary.

In the camping industry, many of the people that use recreational trailers are confronted with the challenge of supplying their trailer with adequate power to run all of the appliances and accessories. As a result, they rely heavily on running a gas- or diesel-powered generator and come across the maintenance issues associated with these items—especially since they are only used seasonally. Also, due to the noise created by these generators, they can be a nuisance to other campers parked in the same vicinity.

The ranch and farm industry also have a need for power tools out on the farm or ranch and they cannot always rely on a generator to provide the necessary power due to mechanical failures, or lack of fuel in the generator, or the cumbersome nature of transporting a heavy generator from location to location.

Vehicles use alternators to generator power, which is supplied to a crank battery and often to vehicle accessories. However, as a vehicle is driven over time, the crank battery reaches capacity and is no longer in need of a charge, while additional power needs may not require the full amount of power generated by the alternator. As a result, the power being generated is left uncaptured and unused—wasted.

While battery management systems have been introduced in an attempt to solve these problems, they fall short. For example, when a user buys a battery management system (e.g., battery charge controller capable of charging two or more batteries), the user must separately purchase and install several other components (e.g., fuse, battery monitors, etc.) and then find a location to install the components. Because there are no ready-to-install systems, many users are left without the benefits of battery management systems. Accordingly, there is a need for an all-in-one system that can capture the excess power created by a vehicle's alternator and store that power for future use. The present disclosure seeks to solve these and other problems.

### SUMMARY OF EXAMPLE EMBODIMENTS

In one embodiment, a vehicle energy management and storage system comprises a housing with a first connection from a crank battery outside of the housing to a first breaker within the housing, a second connection from the first breaker to a DC-DC battery charger, a third connection from the DC-DC battery charger to second breaker, and a fourth connection from the second breaker to one or more storage batteries. The storage batteries are electrically coupled, through a fuse, to a power inverter for inverting 12V DC to 110 AC, which supplies AC power to an outlet. The system may further comprise a shutoff switch, allowing a user to disconnect the system at any time.

In one embodiment, one or more solar panels are electrically coupled to the DC-DC battery charger in addition to the power received from the crank battery. This allows the storage batteries to receive solar power regardless of whether the vehicle alternator is operating.

### BRIEF DESCRIPTION OF THE DRAWINGS

FIG. 1 is a block diagram of a vehicle energy management and storage system;

FIG. 2 is a front elevation view of a housing of a vehicle energy management and storage system;

FIG. 3 is a front perspective view of a panel in a housing of a vehicle energy management and storage system;

FIG. 4 is a rear perspective view of several components mounted to the panel of the housing of the vehicle energy management and storage system;

FIG. 5 is a front, right side perspective view of a housing of a vehicle energy management and storage system with a port for a solar panel connection;

FIG. 6 is a left side perspective view of a housing of a vehicle energy management and storage system having a DC power input connection and a 110V AC outlet;

FIG. 7 illustrates a panel of the vehicle energy management and storage system;

FIG. 8 illustrates a panel of the vehicle energy management and storage system; and

FIG. 9 illustrates a panel of the vehicle energy management and storage system.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a system that can capture and store excess energy produced by a vehicle alternator, and to use additional sources of energy, such as solar, to reduce fuel consumption and harmful emissions. The vehicle energy management and storage system disclosed herein seeks to solve these and other problems.

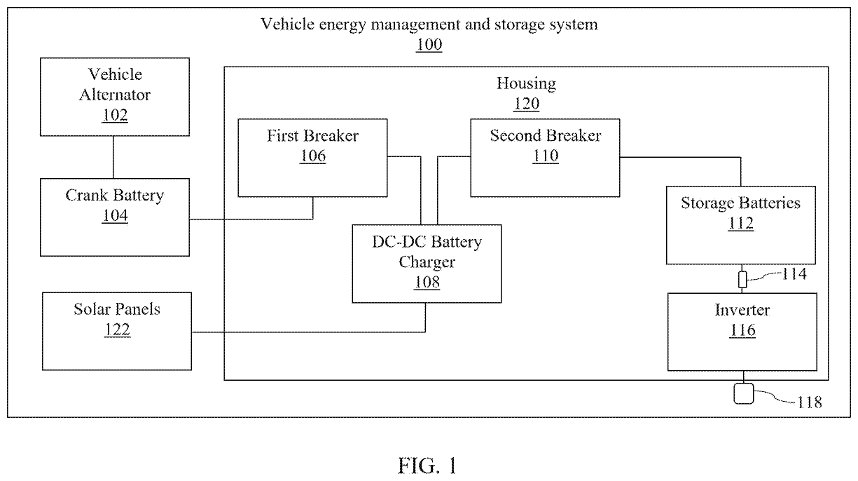

In one embodiment, as shown in FIG. 1, a vehicle energy management and storage system 100 comprises a vehicle alternator 102 coupled to a crank battery 104, with a first connection from the crank battery 104 to a first breaker 106 and a second connection from the first breaker 106 to a DC-DC battery charger 108. The first breaker 106 ensures that the battery charger 108 does not receive excess voltage from the crank battery 104, thereby ensuring the integrity of the battery charger 108. The system 100 further comprises a third connection from the DC-DC battery charger 108 to second breaker 110, and a fourth connection from the second breaker 110 to one or more storage batteries 112. Again, the second breaker 110 ensures that the storage batteries 112 do not receive unsafe levels of power. The storage batteries 112 are electrically coupled, through a fuse 114, to a power inverter 116 for inverting 12V DC to 110 AC, which supplies AC power to an outlet 118.

The system 100 may further comprise a housing 120 for containing one or more components of the system 100. For example, one or more breakers 106, 110 and the DC-DC Battery Charger 108 may be located within the housing 120. In some embodiments, the housing 120 further comprises the inverter 116 and outlet 118. In some embodiments, the storage batteries 112 may also be located within the housing 120. When all the components are located within the housing (except the alternator 102 and crank battery 104), the vehicle energy management and storage system 100 may be adapted and configured to easily fit the needs of vehicles and users.

In an example of use, once the vehicle engine is started, the alternator 102 provides power to the crank battery 104 to ensure it is sufficiently charged. Once the crank battery is fully charged, excess power proceeds to the first breaker 106 and through the remaining components to be stored in the storage batteries 112. It will be appreciated that the DC-DC battery charger 108 may comprise a charge controller to determine when the crank battery 104 is sufficiently charged and to redirect power to the storage batteries 112. This ensures that the crank battery 104 takes priority in charging to ensure it has sufficient charge to start the vehicle. The storage batteries 112 may be as few as one battery or may be a plurality of batteries in a bank. As a result, the longer a user drives or operates a vehicle, the greater the charge in the storage batteries 112.

Because of the inverter 116, this power may be utilized in any number of scenarios, solving the problems earlier mentioned. For example, a commercial trucker may use the storage batteries 112 to power his microwave, TV, or climate controls; a worker may operate tools and equipment; a camper may enjoy power for their RV or other accessories—all without the need to use additional fuel, in silence, and without creating additional harmful emissions. Further, the housing 120 allows a user to easily move and install the system 100 on any vehicle with minimal alterations to the vehicle. A user needs to simply mount the housing 120 in a convenient location and connect the crank battery 104 to the first breaker 106 of the housing 120. Accordingly, the vehicle energy management and storage system 100 overcomes the problems in the prior art. A user may also couple their home to the vehicle energy management and storage system 100, allowing them to utilize excess power generated from their commute to power one or more components in their home, reducing the need for grid power.

In some embodiments, the charge controller may be separate from the DC-DC battery charger. The charge controller may comprise a microcontroller and logic for determining the state of charge of the crank battery 104 and controlling the charge status of the DC-DC battery charger 108. For example, the charge controller may determine when the crank battery 104 exceeds a first voltage, such as that sufficient to start the vehicle, and may then turn “on” the DC-DC battery charger 108 to begin charging the storage batteries 112. If the controller detects a drop in voltage at the crank battery 104, such as below a predetermined threshold, the controller may turn “off” the DC-DC charger 108 to ensure the crank battery 104 has sufficient power to start the vehicle. As discussed earlier, the charge controller may be integrated with the DC-DC battery charger 108. In some embodiments, the charge controller may comprise a wireless transceiver for providing battery status and charge status notifications to a user, such as via Bluetooth® or other wireless technologies.

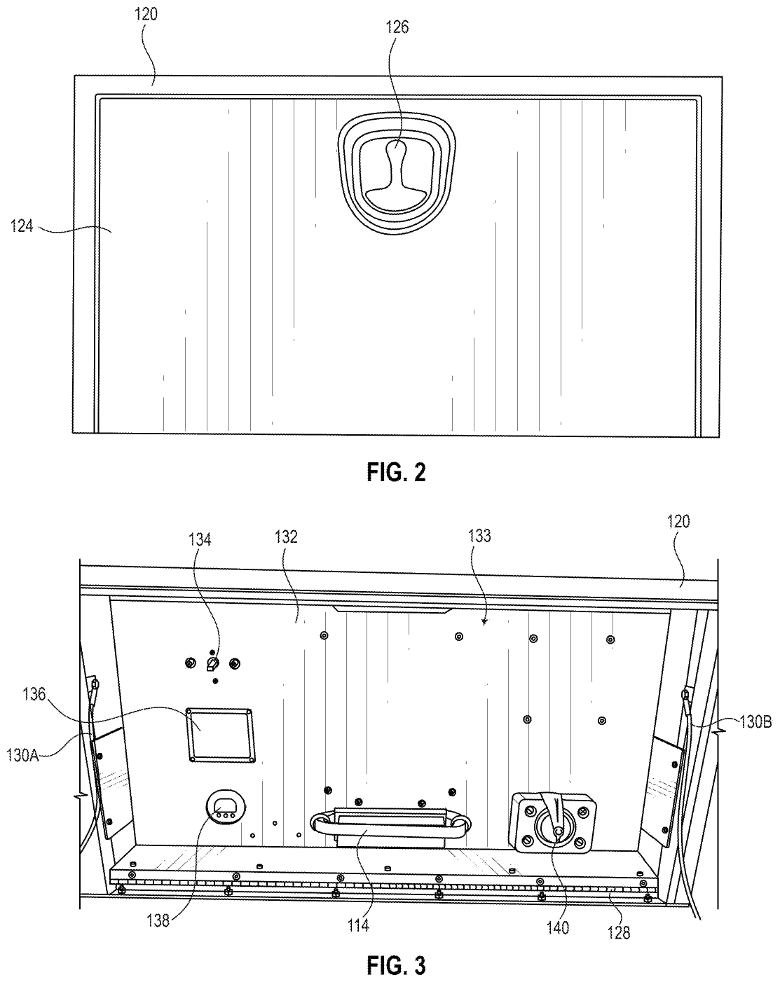

FIG. 2 illustrates a front elevation view of a housing 120. An access door 124 comprises a handle/latch 126, which allows a user to access the components inside the housing 120 (e.g., first breaker 106, DC-DC battery charger 108, second breaker 110, and optionally, one or more storage batteries 112). Referring to FIG. 3, the access door 124 may be hingedly coupled to the housing 120, such as via hinge 128. One or more rods or cables 130A-B may be used to support the door 124 when opened. In some embodiments, a mounting panel 132 comprises a circuit breaker 134 (e.g., 110v, 20 amp), inverter controls 136 (on/off, status, output type, etc.), a battery gauge 138 for indicating battery voltage, charge status (percent, amp hours, etc.), and a shutoff switch 140 allowing a user to disconnect the DC-DC battery charger 108, or terminate power from the storage batteries 112, at any time. As shown, the fuse 114 may be easily accessible from the front side 133 of the panel 132, allowing a user to easily determine its status and replace if needed.

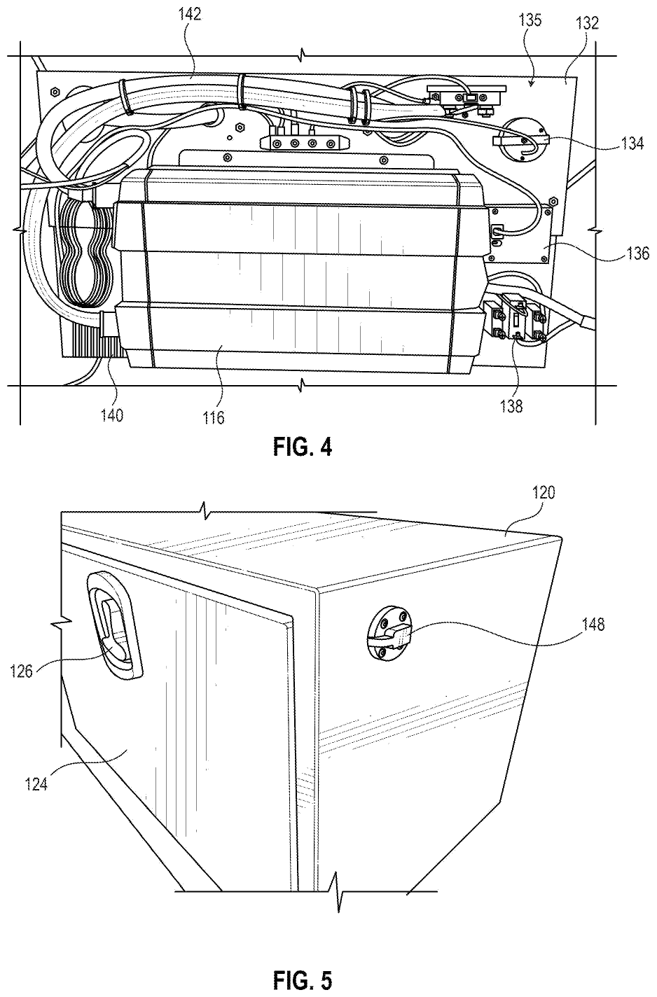

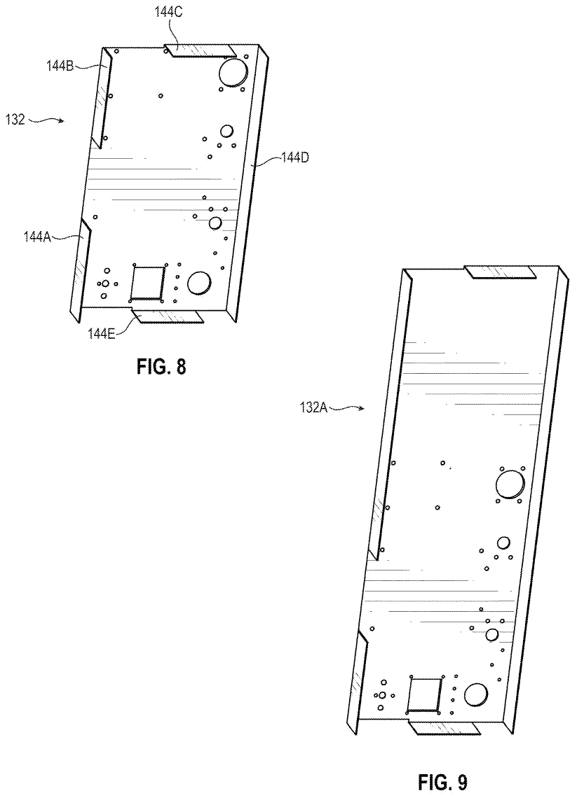

FIG. 4 illustrates a rear side 135 of panel 132. As shown, one or more components (e.g., the reverse side of those shown in FIG. 2) may be coupled thereto, including the inverter 116 and the associated cabling 142 for the components. As shown in FIGS. 7-9, the panel 132, 132A may comprise various sizes and configurations to fit a user's needs. FIG. 7 illustrates the panel 132 as flat sheet metal ready to be bent for mounting in a housing 120. For example, the panel 132 may comprise one or more tabs 144A-E that may be bent (as seen in FIGS. 8-9) and secured (such as by using screws) to the interior walls of the housing 120. The panel 132 may further comprise a plurality of apertures 146A-F for receiving and coupling components thereto. While apertures 146A-F are shown, it will be appreciated that the panel 132 may have more or fewer apertures.

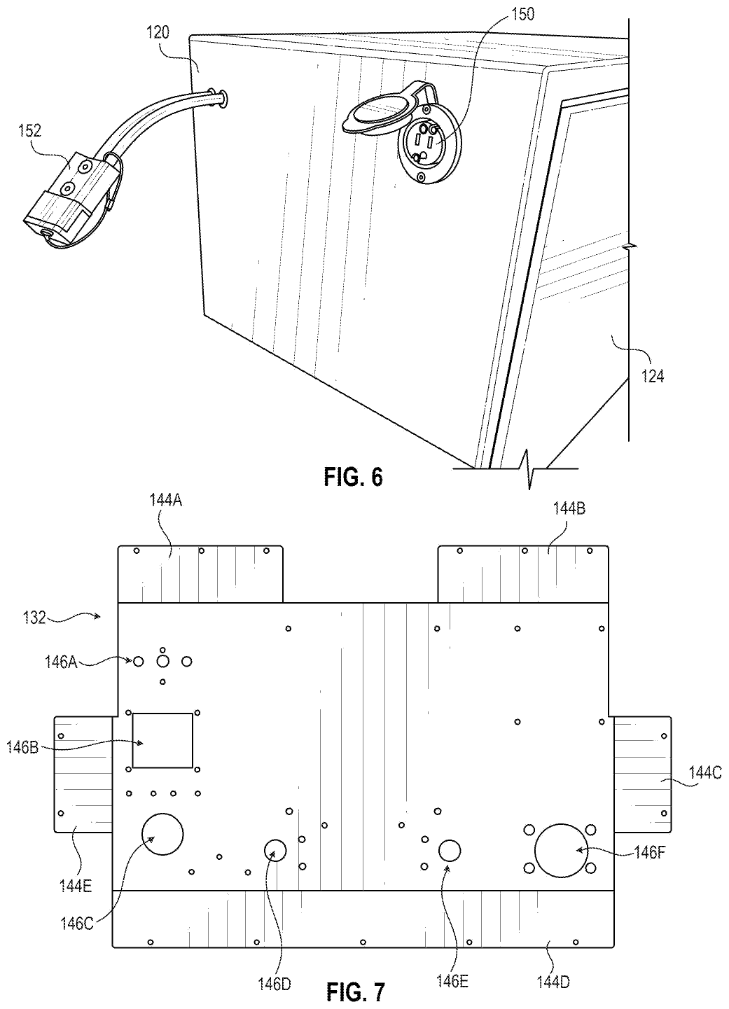

Referring back to FIGS. 5-6, the housing 120 may comprise a solar power connection port 148 for receiving power from one or more solar panels, an AC power outlet 150 (from the inverter 116), and a DC input plug 152 for receiving power from the vehicle (e.g., crank battery, alternator, etc.). In other words, power passes from the vehicle and into the housing 120 via DC input plug 152. The DC-DC battery charger 108, upon determining that the crank battery 104 has a predetermined charge, charges one or more storage batteries 112 (which may be stored within the housing 120 or external thereto) or other auxiliary batteries. These outlets and plugs allow a user to easily install and use the system 100 without needing to separately mount breakers (106, 110), a DC-DC battery charger (108), an inverter 116, or other components, overcoming limitations in the prior art. In other words, in the prior art, a user must separately mount each component to a vehicle and make the appropriate connections between components. Understanding the components needed and the connections is difficult and may be dangerous for users to self-install. In contrast, a user may simply mount the housing 120 disclosed herein and make a single connection (e.g., crank battery 104 to DC input plug 152). From there, the vehicle energy management and storage system 100 is ready to use, allowing a user to insert a plug into power outlet 150 to power devices. This allows even users without electrical backgrounds to install and use battery chargers and inverters on vehicles more safely and easily, overcoming limitations in the art.

Referring back to FIG. 1, in some embodiments, one or more solar panels 122 may be electrically coupled to the DC-DC battery charger 108 in addition to the power received from the crank battery 104. This allows the storage batteries 112 to receive power regardless of whether the vehicle alternator 102 is operating. In some embodiments, a charge controller (which may be integrated with DC-DC battery charger 108) may direct power from the solar panels 122 to the crank battery 104 if it detects the crank battery 104 is below a predetermined threshold, or may direct power to the storage batteries 112 or other components when excess power is available. The solar panels 122 may be coupled to the housing 120 or may be located elsewhere on the vehicle.

Accordingly, it is clear from the foregoing that the vehicle energy management and storage system 100 solves many problems in the prior art. As a few, non-limiting, examples: 1) it allows over-the-road truckers to enjoy the amenities of their cabs without needing to leave the engine idling; 2) it allows engine block heaters and other necessary accessories to function; 3) it allows industrial workers, farmers, and others to power or charge on-site tools and equipment; 4) it allows campers to have power for their needs without the need of additional fuel and noise; 5) it provides power back to the user's house and/or the power grid, reducing overall power consumption; and 6) the system may be easily moved and installed on a desired vehicle with ease due to the housing 120 with components therein. The more a user can store and use excess energy, either from the alternator or from the solar panels, less fuel is consumed, and less emissions are produced, creating a better global environment.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A vehicle energy management and storage system, comprising:
a housing, comprising:
a DC input plug accessible on an exterior of the housing,
a panel secured to an inside of the housing,
a first breaker,
a DC-DC battery charger coupled to the first breaker,
a second breaker coupled to the DC-DC battery charger,
one or more storage batteries coupled to the DC-DC charger,
a fuse coupled to the one or more storage batteries,
an inverter coupled to the fuse, and
an AC power outlet coupled to the inverter;
wherein the DC input plug is configured to receive power from a vehicle.

2. The vehicle energy management and storage system of claim 1, wherein the DC-DC battery charger comprises logic to determine when a crank battery has met or exceeded a predetermined threshold and, upon determining that the threshold has been met, is configured to charge the one or more storage batteries.

3. The vehicle energy management and storage system of claim 1, further comprising solar panels coupled, and providing solar power, to the DC-DC battery charger.

4. The vehicle energy management and storage system of claim 1, further comprising a shutoff switch.

5. The vehicle energy management and storage system of claim 1, wherein the housing further comprises a hingedly coupled access door having a latch.

6. The vehicle energy management and storage system of claim 5, wherein the fuse is positioned on a front side of the panel and accessible via the hingedly coupled access door.

7. The vehicle energy management and storage system of claim 1, wherein the panel comprises a plurality of tabs configured to be secured to the inside of the housing.

8. A vehicle energy management and storage system, comprising:
a housing, comprising:
a DC input plug accessible on an exterior of the housing,
a panel comprising a plurality of tabs, wherein each tab is secured to an inside of the housing,
a first breaker mounted to the panel,
a DC-DC battery charger mounted to the panel and electrically coupled to the first breaker,
a second breaker mounted to the panel and electrically coupled to the DC-DC battery charger,
one or more storage batteries electrically coupled to the DC-DC charger,
a fuse mounted to the panel and electrically coupled to the one or more storage batteries,
an inverter mounted to the panel and electrically coupled to the fuse,
an AC power outlet electrically coupled to the inverter and accessible on an exterior of the housing, and
a solar power connection port accessible on the exterior of the housing;
wherein the DC input plug is configured to receive power from a vehicle battery and the solar power connection port is configured to receive power from one or more solar panels.

9. The vehicle energy management and storage system of claim 8, wherein the DC-DC battery charger comprises logic to determine when the vehicle battery has met or exceeded a predetermined threshold and, upon determining that the threshold has been met, is configured to charge the one or more storage batteries.

10. The vehicle energy management and storage system of claim 8, further comprising a shutoff switch.

11. The vehicle energy management and storage system of claim 8, wherein the housing further comprises a hingedly coupled access door having a latch.

12. The vehicle energy management and storage system of claim 11, wherein the fuse is positioned on a front side of the panel and accessible via the hingedly coupled access door.

13. A vehicle energy management and storage system, comprising:
a vehicle comprising an alternator and a crank battery;
a housing, comprising:
a DC input plug accessible on an exterior of the housing,
a panel comprising a plurality of tabs, wherein each tab is secured to an inside of the housing,
a first breaker mounted to the panel,
a DC-DC battery charger mounted to the panel and electrically coupled to the first breaker,
a second breaker mounted to the panel and electrically coupled to the DC-DC battery charger,
one or more storage batteries electrically coupled to the DC-DC charger,
a fuse mounted to the panel and electrically coupled to the one or more storage batteries,
an inverter mounted to the panel and electrically coupled to the fuse,
an AC power outlet electrically coupled to the inverter and accessible on an exterior of the housing, and
a solar power connection port accessible on the exterior of the housing;
wherein the DC input plug is electrically coupled to the crank battery and the solar power connection port is configured to receive power from one or more solar panels; and
wherein the DC-DC battery charger comprises logic to determine:
i. when the crank battery has met or exceeded a predetermined threshold and, upon determining that the threshold has been met, is configured to charge the one or more storage batteries, and
ii. when the crank battery is below the predetermined threshold and, upon determining that the crank battery is below the predetermined threshold, is configured to charge the crank battery using solar power from the one or more solar panels.

14. The vehicle energy management and storage system of claim 13, further comprising a shutoff switch.

15. The vehicle energy management and storage system of claim 13, wherein the housing further comprises a hingedly coupled access door having a latch.

16. The vehicle energy management and storage system of claim 15, wherein the fuse is positioned on a front side of the panel and accessible via the hingedly coupled access door.
